(19) United States
(12) Patent Application Publication
(10) Pub. No.: US 2001/0047365 A1
(43) Pub. Date: Nov. 29, 2001

(54) System and method of packaging and unpackaging files into a markup language record for network search and archive services

(75) Inventor: Robert B. Yonaitis, Concord, NH (US)

Correspondence Address: BOURQUE & ASSOCIATES, P.A., 835 HANOVER STREET, SUITE 303, MANCHESTER, NH, 03104, US

(73) Assignee: Hiawatha Island Software Co, Inc.

(21) Appl. No.: 09/837,695

(22) Filed: Apr. 18, 2001

Related U.S. Application Data
(60) Provisional application No. 60/198,520, filed on Apr. 19, 2000.

(51) Int. Cl. G06F 17/30

(52) U.S. Cl. 707/200; 707/3

(57) ABSTRACT

A system and method for packaging and unpackaging files using a markup language wrapper for network search and archiving services. The method begins by creating at least one package of metadata to associate with at least one file. Then, at least one file to which the created package of metadata is to be associated is selected. Next, a metapackage is created by embedding the package(s) of metadata and the selected file(s), in their original form, into a markup language record. The created metapackages may then be provided for search over a computer network, where they can be searched and retrieved based on desired metadata values. Once retrieved, at least one file is extracted from the retrieved metapackage(s) for viewing by a searcher in their original form.

### CROSS-REFERENCE TO RELATED APPLICATIONS

This application claims the benefit of U.S. Provisional Patent Application Serial No. 60/198,520, filed Apr. 19, 2000, which is fully incorporated herein by reference.

### TECHNICAL FIELD

The present invention relates to a system and method of packaging and unpackaging information to facilitate searching a computer network for that information. More particularly, the invention concerns a system and method that automatically applies structured or semantic markup language metadata to documents via a graphical user interface. The graphical user interface allows metadata values to be entered with little or no understanding of structured or semantic markup languages, such as HTML, SGML or XML.

### BACKGROUND INFORMATION

The use of computer networks and in particular, large scale networks, such as the Internet, has dramatically changed the way people access information. In fact, with a computer connected to the Internet over a telephone line, a person can have access to countless sources of information, including complete library collections as well as marketing and product information. However, the vast amount of information that is available using such large scale computer networks, such as the Internet World-Wide-Web has created problems that are currently insurmountable using currently available technology.

An example of a specific problem involves searching for information on the Internet. Currently, Internet searching relies heavily on catalogs that are provided by a variety of search service providers, such as Yahoo, Alta Vista, Excite, Netscape and others, which all provide publicly accessible search engines via the Internet World-Wide-Web. The search services provided by these companies typically use a catalog of information that is built by the service provider in response to the receipt of a collection of documents that it receives and indexes. The collection of documents are classified according to a set of rules developed by the search service provider and are then cataloged according to the classification schema. After the documents are classified and cataloged, the service provider then prepares a user query interface that allows an information seeker to search the catalog according to the schema. The user interface is then provided to information seekers over a computer network, such as the Internet or an intranet portal.

However, a significant drawback of this method is that it requires a large amount of computer programming expertise to code indexing interfaces, which means that the average user, or document manager cannot set up a indexed catalog without assistance. Another problem is that the many document types do not allow for the embedding of properties and most of the indexing vendors only support a limited number of document types. Therefore, the accuracy of a collection and the ability to retrieve essential information successfully is decreased.

In addition, different servers have diverse meanings/mappings of fielded elements. This complicates the search process and makes it a nearly an impossible task for classified catalogs to interoperate with other catalogs. Thus, the sharing or collaboration of information is greatly impeded. This prevents web surfers or research specialists from being able to find all of the available resources on a topic, which generally leads to less then comprehensive search results.

On the other hand, if one were to chose not to apply the logic of fielded searching, a search would result in the return of a haystack of results when the searcher is desires only a needle that is hidden in the haystack. Simply put, while full text search is important it produces less than desirable results.

Accordingly, what is needed is a system and method for markup language packaging and unpackaging of documents for network search and archive services that provides interoperability of services. To be viable, such a system and method must eliminate the currently required high skill level required to code search/index interfaces. It should also eliminate document type dependencies of indexing or gathering. In addition, such a system and method should provide fielded searching of all document types without having to code custom interfaces.

### SUMMARY

The system of the present invention satisfies these needs by providing a markup language packager, which automatically applies metadata values to documents via a wizard interface. Using the markup language packager, a document or other file can be wrapped with markup language code, which will make it indexable based on a core, customizable metadata structure. In the preferred embodiment, the system utilizes the XML document encoding standard to encapsulate documents or groups of documents into an XML record. The XML standard allows for the packaging of any document type into a rich metadata XML wrapper. The use of the XML standard also allows open integration to virtually any and all existing XML servers.

While markup language-packaged files provide indexing, once retrieved, they need to be extracted from their markup language wrappers to be used in their native format. To do this the system of the present invention also provides a markup language unpackager, which unpackages, unwraps or extracts a file.

A method of packaging and unpackaging according to one embodiment of the invention begins by creating a package of metadata to apply to a file or group of files. Preferably, the metadata package creation is accomplished using a wizard-type user interface to allow metadata packages to be created by users with little or not computer programming knowledge.

After a package of metadata is created, the user then identifies which file or files to which the package of metadata is to be applied. Once the file or files are identified, a metapackage is built. Once build, a metapackage includes the defined package or metadata as well as the selected file or files, in their original format. Accordingly, when files are identified and retrieved at a later date, they can be viewed in their original forms.

Once metapackages are created, they are stored for future identification and retrieval. When a metapackage is retrieved at a later date, the metapackage is unpackaged, which strips the original file from the metapackage and makes it available for viewing.

### BRIEF DESCRIPTION OF THE DRAWINGS

These and other features and advantages of the present invention will be better understood by reading the following detailed description, taken together with the drawings wherein:

FIG. 1 is a block diagram of the components of one embodiment of a metadata packaging and unpackaging system according to the present invention;

FIG. 2 is a screen display of a wizard-type user interface, which is used to define metapackages;

FIG. 3 is a screen display of an XML structure view, which displays metapackages in a hierarchical tree format;

FIG. 4 is a screen display showing the XML source code for a defined metapackage;

FIG. 5 is a screen display of a document type description (DTD) view of a defined metapackage;

FIG. 6 is screen display of one example of a metapackage build interface;

FIG. 7 is an example of a processing display, which provides the status of a metapackage build while the build is in progress;

FIG. 8 is a screen display of one example of a metapackage extraction interface; and

FIG. 9 is a flow diagram of a process of packaging and unpackaging files into and out of metapackages according to the teachings of the present invention.

### DETAILED DESCRIPTION OF THE PREFERRED EMBODIMENTS

The present invention provides a system and method of adding metadata to files to facilitate document management, indexing and retrieval. However, instead of forcing metadata into a variety of diverse document types, the system and method of the present invention embeds files into a markup language wrapper (hereinafter referred to as a “metapackage”). In addition to the embedded file, each metapackage contains rich metadata—thereby allowing all document types to be available for field searching. Examples of file types that can be embedded into a metapackage include but are not limited to wave files, Microsoft® Office® documents, industrial drawings and maps, scanned documents, graphics and multimedia files and web documents.

Once packaged, files can be indexed and retrieved by servers and search engines that would otherwise be unable to identify and access the files. Accordingly, the system and method of the present invention brings the power of a database to document collections without requiring a database management application.

In the preferred embodiment, the markup language wrapper utilized by the disclosed system and method is an XML wrapper. The use of the XML format ensures that current document management systems will be able to read, index and retrieve metadata-packaged documents on demand. While the use of the XML standard provides virtually universal interoperability of the system, the invention is not limited to the use of the XML standard and is equally applicable to other structured or semantic markup language standards.

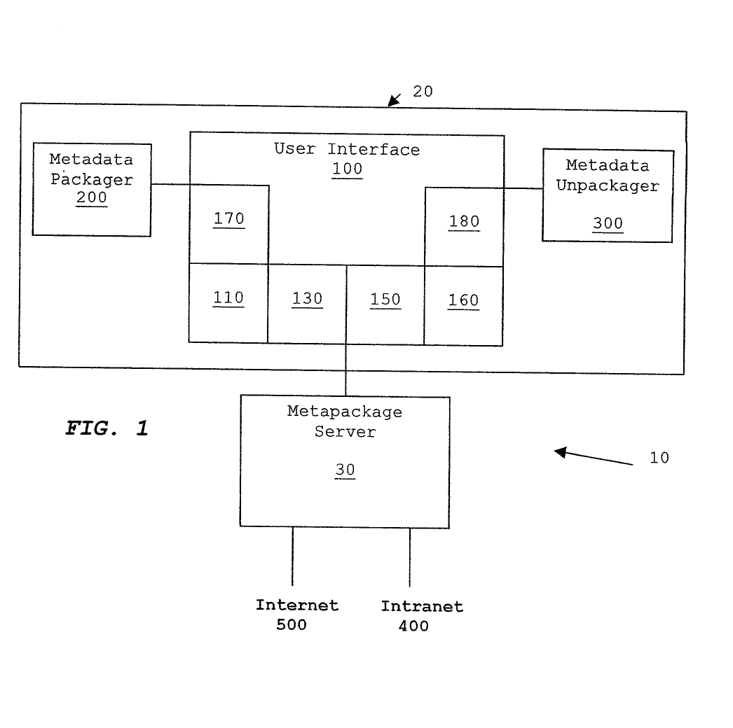

Turning now to the figures and, in particular, FIG. 1, a metadata management system 10, which is especially configured to provide for the rapid packaging and unpackaging of files and groups of files with rich metadata is provided. The metadata management system 10 includes a metapackager client 20 and a metapackager server 30. In one embodiment, the metapackager client 20 is provided as a software application that runs on a standard personal computer and includes a metapackager user interface 100 a metadata packager 200, and a metadata unpackager 300. The metapackager server 30 provides a link between the metadata management system 10 and a network, such as an intranet 400 or a wide area network, such as the Internet 500. The metapackager server is also provided, in one embodiment, as a software application running on a personal computer, which may be the same computer running the metapackager client or a different computer.

The metapackager client 20 provides the components necessary to define, create and extract metapackages. The first component of the metapackager client 20 is the metapackager user interface 100. In one preferred embodiment, the user interface 100 is a wizard-like graphical user interface, which, as will be explained in more detail below, provides a set of tools that allow system users to create metadata-rich, metapackages using a simple point-and-click interface. Thus, the metadata packager allows users to embed files with rich metadata with little or no computer programming knowledge.

The user interface 100 includes a metadata application wizard 110 (FIGS. 1&2). The metadata application wizard 110 is used to create a set of metadata tags and values to embed with a file into a metapackage. The metadata application wizard 110 includes a custom subject window 112, where one or more custom subject tags may be defined, edited and saved. Custom subject tags allow a user to apply controlled vocabularies for meta tag names to provide consistency in meta tag definitions among a number of related files.

The metadata application wizard 110 also includes a package meta tag toolbar 114, which includes a meta tag select schema window 116. Schemas are useful for defining enterprise-wide metadata schemas. By defining multiple metadata schemas, a user can effectively use the metadata packager for applying metadata to files provided by different enterprises, which may include, for example, different companies or different divisions within a company. In any case, once a schema is selected, it may be changed, deleted and saved by a user by selecting the appropriate user-selectable action icon 118.

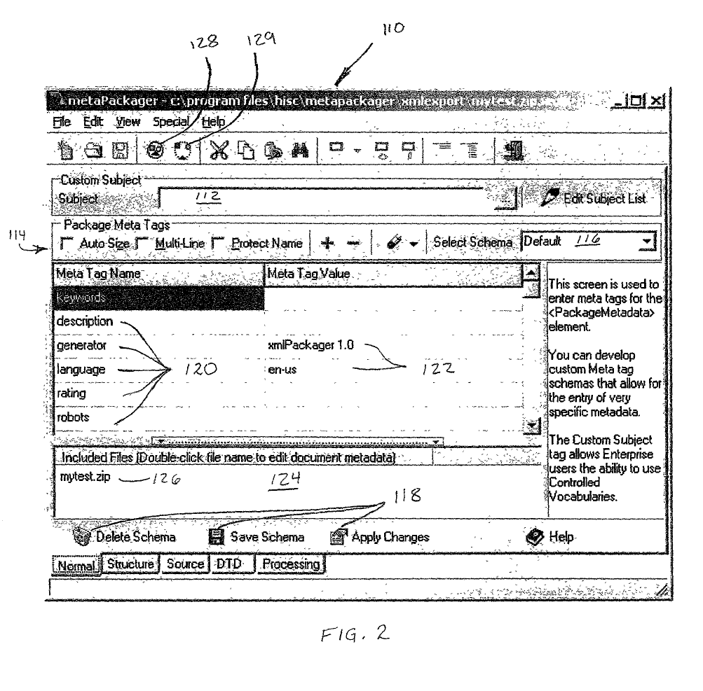

Once a schema has been selected, meta tag names defined for that schema are displayed in a meta tag name list 120. Corresponding to each defined meta tag name appearing in meta tag name list 120 is a meta tag value field 122, where a user may input value to associated with a defined meta tag name. Of course, a user may input any number of meta tag values and is not required to provide a value for each defined meta tag. When the meta tag values are entered by the user, the user can then select one or more files to include with the meta tag values from an included file window 124. In the example of FIG. 2, the file “mytest.zip” 126 to which the metadata is to be applied may selected from a list of files displayed in the included file window 124.

The metadata application wizard 110 also includes metapackage build and unpackage icons 128 and 129, respectively, which will be described in more detail below.

In the example shown in FIG. 2, a package of metadata including meta tags named “generator” and “language” having meta tag values of “xmlPackager 1.0” and “en-us”, respectively are being embedded into a metapackage, which also includes a file named “mytest.zip”. The file extension for a metapackage is “.xmlp”. So, for the example shown, the file name for the metapackage including the file, “mytest.zip” is identified as “mytest.zip.xmlp”.

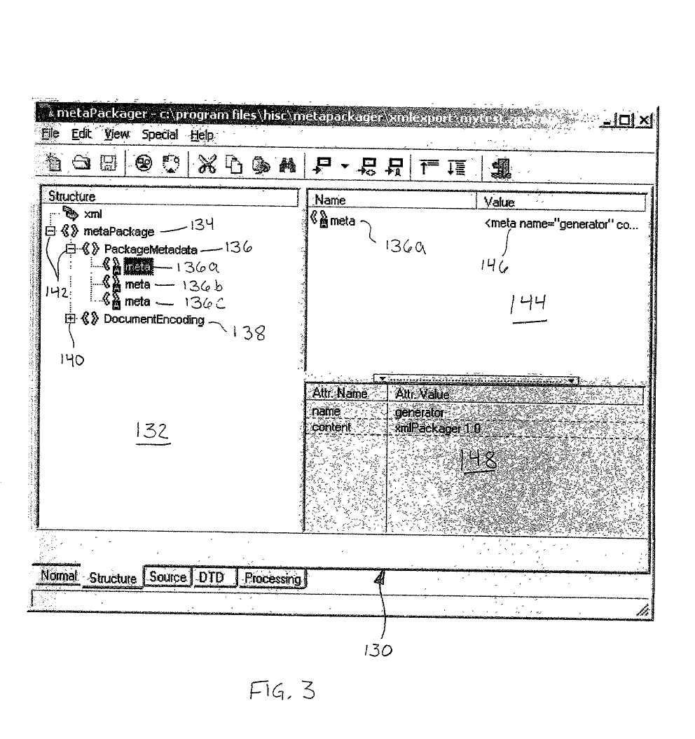

The user interface 100 (FIG. 1) also includes interfaces, which allow users to view defined metadata and metapackages in alternative formats. For example, as shown in FIG. 3, one alternative format is provided in a structure view 130. The structure view 130 includes a structure window 132. The structure window is where XML-based metapackages are displayed in a hierarchical tree structure. In the example shown, a single metapackage 134 is shown. The metapackage 134 includes a package or metadata 136, which includes three metadata elements 136a-c. The metapackage 134 also includes a file indicated by “DocumentEncoding” 138. By selecting expansion and contraction icons, indicated by “+sign” 140 and “−sign” 142, more specific details about packaged metadata elements or embedded files can be shown or hided, as desired.

The structure view 130 is useful in displaying complex metapackage structures. One feature of the present invention is that metapackages can be layered. Layered metapackages, also known as “Onion” packages, are layered metapackages where metapackages are stored within metapackages. For example, an entire collection of files related to a specific topic may be included in a metapackage that contains metadata values that are applicable to all of the files. However, for certain of those files, additional metadata values may be desirable for archiving and future search services. In that case, the first metapackage, which contains all of the related files may include one or more additional metapackages, which would include the additional metadata elements and the embedded files with which they are associated. As can be appreciated, the structure view provides a graphical representation of such a scheme in an easy to understand format.

The structure view 130 also includes a metadata window 144, in which a meta tag name and its metadata value 146 associated with a highlighted meta tag 136a may be displayed in a source code format. The structure view also displays the same information in a tabular format window 148.

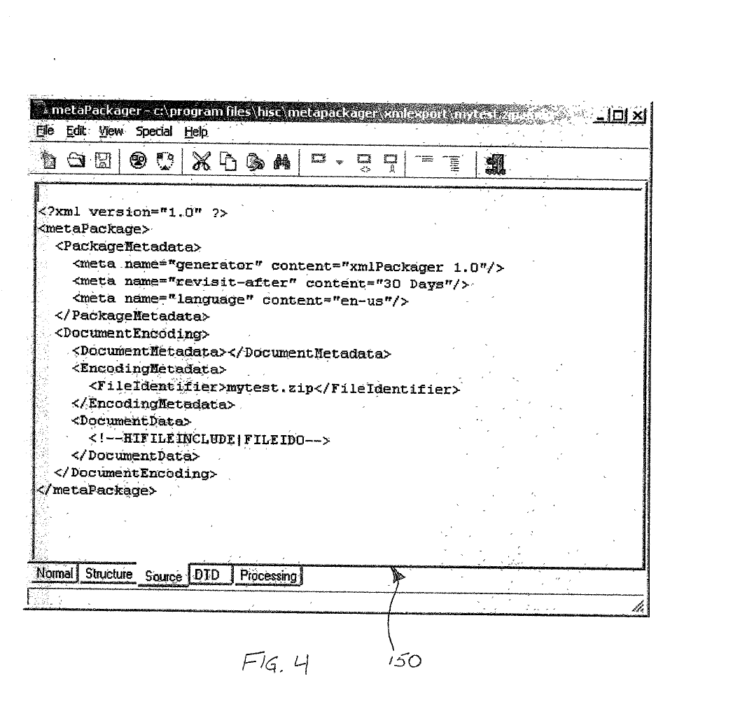

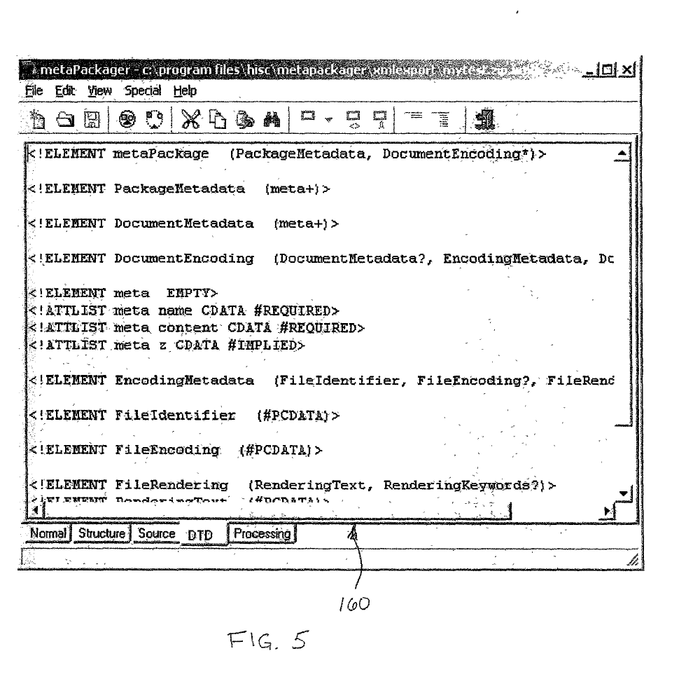

Another useful format for displaying metapackages is provided by a source view 150 (FIG. 4). The source view displays a defined metapackage in a source code format and is especially useful for use by skilled computer programmers who are familiar with source code formatting. FIG. 5 shows a document type description (DTD) view 160, which is yet another format for viewing defined metapackages.

Once a metapackage is defined by a user using, for example, the metadata application wizard 110 (FIG. 2), an actual metapackage is created by the metadata packager 200 (FIG. 1) upon the selection of the build package icon 128 FIG. 2). The metadata packager is a markup language processor, which generates markup language code to create a markup language wrapper that includes both the package of metadata and the file or files defined by a user using the metadata application wizard. In one preferred embodiment, the metadata packager uses the XML encoding standard to encapsulate metadata and files into an XML record.

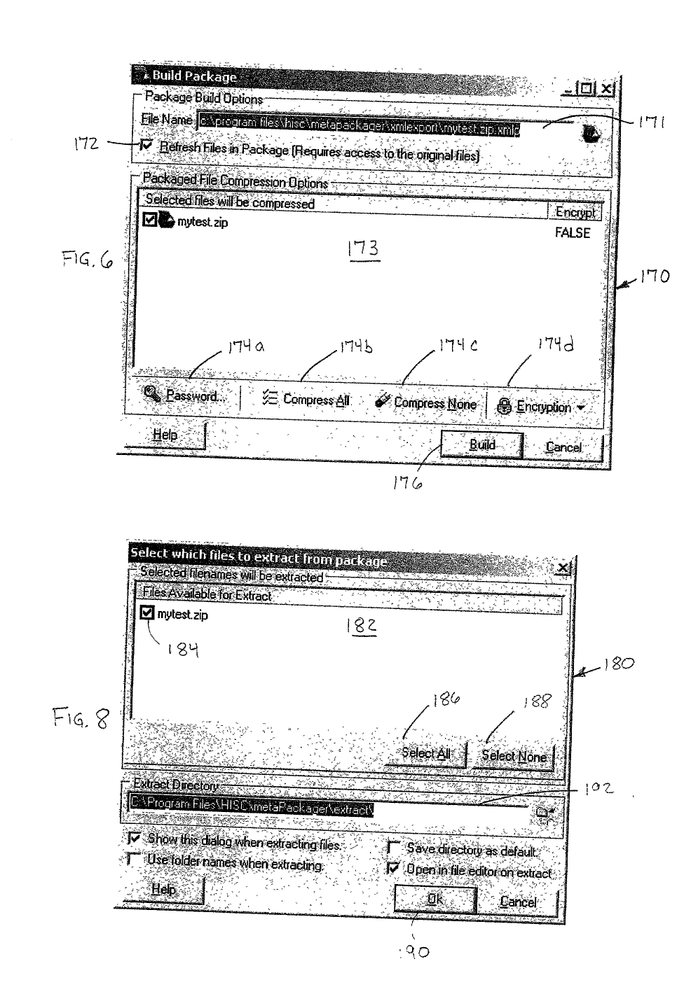

When the build package icon 128 is selected, a build package interface 170 (FIG. 6) is provided. The build package interface 170 provides a number of build package options. For example, in addition to displaying the file name in a file name window 171, which includes a directory structure associated with the file, the options allow files in a package to be refreshed, provided access to the original packaged files is available. The file refresh option is selected by checking the refresh check box 172.

The build package interface 170 also includes a packaged file compression option window 173. The compression option window provides user-selectable icons 174a-d for applying password protection, compression, encryption or any combination thereof to one or more selected file to be compressed. Once any encryption options are selected, then the actual metapackage build is initiated by selecting the build icon 176.

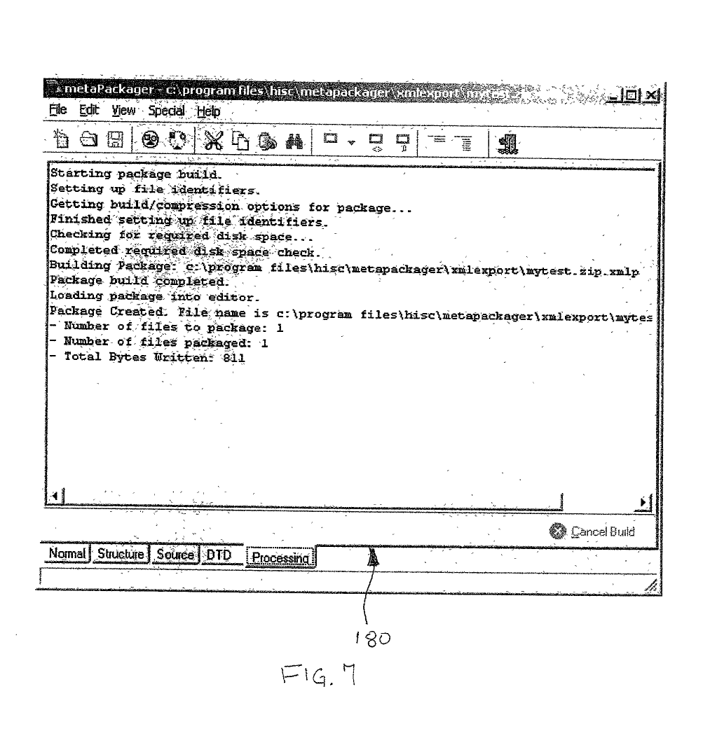

Upon selection of the build icon 176, a package processing display 180 (FIG. 7) is displayed. The package processing display provides a status of a metapackage build as the metapackage is being generated by the metadata packager processor 200 (FIG. 1).

The distribution of metapackages is just as important as the use of the metapackages. By integrating the Metapackage server 30 with Microsoft® Internet Information Server®, server-based distribution of metapackages is facilitated in a manner that makes the metapackages invisible to the package user. Accordingly, once metapackages are created, the metapackager server 30 (FIG. 1) provides for the distribution of HTML representations of metapackages via intranet 400 or Internet 500 portals to consumers, employees, or citizens in a way that assures that they will never have to understand or have any knowledge of the actual structure of a metapackage.

As indicated above, the metadata packager 200 provides a pure XML solution with compression and base64 encoding that facilitates the encapsulation of files in pure XML. Thus, a metapackage contains at least one original file (and quite possibly an entire collection of files) combined with metadata within a standard XML file.

The metadata application wizard 110 (FIG. 2) also provides the portal by which metapackages can be unpackaged to provide a user with an original file, in its original form. By selecting the extract file icon 129, an extract file interface 180 (FIG. 8) is provided. The extract file interface 180 displays a list of files available for extraction in an available file window 182. Check boxes 184 as well as “select all” and “select none” icons 186 and 188, respectively, are provided to allow a user to rapidly select those files that he or she would like to extract from a metapackage. When one or more files are selected, then selecting an “O.K.” icon 190 will initiate the extraction of the selected file or files from a metapackage using the metadata unpackager 300 (FIG. 1). The extracted file will be placed in an extract directory, which may be defined by the user in an extract directory window 192.

Therefore, once a file is embedded into a metapackage, the only copy of that file that needs to be maintained on a storage device is the copy of the file embedded into the metapackage.

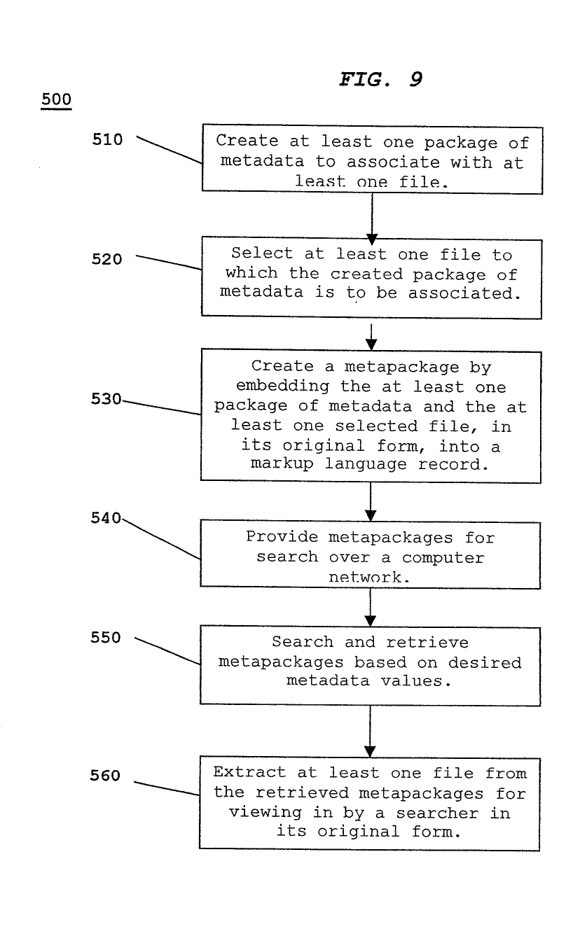

FIG. 9 shows one embodiment of a method 500 of packaging and unpackaging files using a markup language for network search and archive services. The method begins by creating at least one package of metadata to associate with at least one file, step 510. In one preferred embodiment, the metadata package creation step is accomplished using a wizard-based user interface to facilitate the creation of packages of metadata.

Once a package of metadata, including meta tag names and meta tag values, is created, at least one file to which the package of metadata is to be associated is selected, step 520. Again, in the preferred embodiment, a wizard-based user interface facilitates the file selection step. As indicated earlier, a single package of metadata or multiple packages of metadata can be associated with a plurality of files, such as all files associated with a specific project.

Once a metadata package is created and at least one file to which the metadata is to be associated is selected, then, in step 530, a metapackage is created or built. Each metapackage is a markup language record containing at least one package of metadata and at least one embedded file, in its original form. In the preferred embodiment, the metapackages are created using an XML document encoding standard to encapsulate files or groups of files into an XML record that also contains the metadata package. Therefore, instead of attempting to embed metadata elements into an existing file, a new XML record is created, which includes the metadata associated with the file and the file itself, in its original form. Accordingly, this method allows for the application of metadata packages to virtually all document types and facilitates the application of metadata to entire catalogs of existing files without the necessity of editing or otherwise modifying any of the files themselves.

Once metapackages are build, they may be made available for search services over a computer network, step 540. For example, a company may make all of its metapackages available over a company wide intranet or even to a larger potential audience via a wide area network, such as the Internet.

The metadata associated with such metapackages may then be searched and documents retrieved based on desired metadata values, step 550. Once a metapackage is retrieved, then the file or files associated with the metapackage may be extracted from the package and viewed by a searcher in their original form, step 560.

In order to provide the desired processing speed and to preserve the native format of embedded files and to allow for rapid file extraction, the markup language processor or metapackager utilizes the following sequence of events. First, metadata properties are defined and are written to a file. Next, markup closure is added and is written to a file. Then, these two files along with the file that is to be embedded into the markup language record are combined using sized block functions for speed and to eliminate file corruption for non-text files. Preferably, the method utilizes streaming and byte arrays for speed and stability. The following is a pseudo-code listing detailing the steps of creating a markup language record including metadata elements and at least one embedded file.

Creating an XML record with metapackager

Start metapackager program

Select File | New | XML Package from the main menu

Create New File screen is presented

Choose Create Package radio option

Select previously created template file

Choose OK

Screen closes and selected template file is loaded into metapackager

On the ‘Normal’ tab page

This is where the Package level metadata for the package is entered (the PackageMetadata element)

Use the custom subject selector to build a controlled subject metadata value

Use the ellipse button to display the Subject Selector dialog

Choose the vocabulary from the Vocabulary dropdown list

This loads the subject tree with the selected vocabulary file

Choose the subject from the tree

Once selected, press the add or replace button to either add to or replace the current subject respectively.

Select the metadata schema to use from the Select Schema drop down list

This loads the selected metadata schema file into the grid with metadata names in the left column and metadata values in the right column.

Edit the metadata names and add metadata values in the grid as desired.

Press the Apply Changes button on the bottom toolbar to update the PackageMetadata element in the package definition.

Process steps

Goes through the package metadata schema grid row by row and, if there is a value in the metadata value column, adds or updates (if existing) a meta sub element with the name attribute specified in the Metadata Name column and the content attribute specified in the Metadata Value column, in the PackageMetadata element in the package definition.

If the custom subject edit field is not empty it adds or updates (if existing) a meta sub element with the name attribute specified by the custom subject identifier and the content attribute specified in the custom subject edit field, in the PackageMetadata element in the package definition.

Add File(s) to be packaged

Select File | Add File(s) from the menu

This brings up the default windows open file dialog box

Browse to the folder where the file(s) is located and select the files to add

Press the Open button to close the dialog and select the file(s)

The system steps though the list of selected files and, if not already included in the package, adds a reference to each file to the package definition.

Process steps for each file to be added

Creates a DocumentEncoding element in the package definition with the following sub elements

DocumentMetadata

DocumentData

EncodingMetadata

A FileIdentifier sub element is created with the file's full path and name as the element text and added to the new EncodingMetadata sub element.

The file's full path and name are added to the list of included files and a reference to the new DocumentEncoding element is associated with it.

Add Document Metadata to the package

Select a file in the included files list and Double-Click on the name to bring up the Document Metadata screen loaded with the

This is where the File level metadata for the selected file in the package is entered (the DocumentMetadata element)

If any Document Level metadata exists within the package definition for the selected file then any matching metadata names in the metadata schema, set as the default and loaded automatically,

Use the custom subject selector to build a controlled subject metadata value

Use the ellipse button to display the Subject Selector dialog

Choose the vocabulary from the Vocabulary dropdown list

This loads the subject tree with the selected vocabulary file

Choose the subject from the tree

Once selected, press the add or replace button to either add to or replace the current subject respectively.

Select the metadata schema to use from the Select Schema drop down list

This loads the selected metadata schema file into the grid with metadata names in the left column and metadata values in the right column.

Edit the metadata names and add metadata values in the grid as desired.

Press the Ok button on the bottom to close the dialog and update the DocumentMetadata element for the file in the package definition.

Process steps

Goes through the document metadata schema grid row by row and, if there is a value in the metadata value column, adds or updates (if existing) a meta sub element with the name attribute specified in the Metadata Name column and the content attribute specified in the Metadata Value column, in the DocumentMetadata element for the selected file in the package definition.

If the custom subject edit field is not empty it adds or updates (if existing) a meta sub element with the name attribute specified by the custom subject identifier and the content attribute specified in the custom subject edit field, in the DocumentMetadata element for the selected file in the package definition.

Build Package

Select File | Build Package from the main menu

Applies Package level metadata changes

Process steps

Goes through the package metadata schema grid row by row and, if there is a value in the metadata value column, adds or updates (if existing) a meta sub element with the name attribute specified in the Metadata Name column and the content attribute specified in the Metadata Value column, in the PackageMetadata element in the package definition.

If the custom subject edit field is not empty it adds or updates (if existing) a meta sub element with the name attribute specified by the custom subject identifier and the content attribute specified in the custom subject edit field, in the PackageMetadata element in the package definition.

Sets Up File Identifiers in package definition

Process Steps

Verifies that a template has been loaded to create a package and that the process was started after either loading an existing package or creating a new one.

List of DocumentEncoding elements from the package definition is obtained from package definition.

Validates that number of DocumentEncoding elements matches the number of files to be included in the package. If they do not match, the process is failed.

Validates that each file to be included has one of the DocumentEncoding elements associated with it. If any do not, the process is failed.

Creates the build package dialog box.

Steps through the list of files to be included and adds each file in the list into the list view with the following sub items/properties:

The full file path and name of the file (appears in the first column)

The compression option for the file (if the file is set to be compressed the item has a checkmark to the left of the file name, otherwise no checkmark appears. By default all new files are set to be compressed)

The encryption option (if the file is to be password protected) for the file (if the file is set to be encrypted, the word TRUE appears in the column named Encrypt, otherwise the word FALSE appears in the same column.)

A unique file identifier is generated and added to a ‘hidden’ column. The DocumentData element content in the package definition, for the file, is also updated with the file id.

A default, unique, file name for the package is selected and populated in the file name field.

The build package dialog is displayed to the user and the user then selects the build options for the files being packaged.

If there are existing packaged files within the package definition, the user has the option to refresh those files from their source. By default this option is selected.

For each file the user has the option to compress and, if compression is chosen, to encrypt the file. If the user chooses to encrypt any file, then they are required to add a password by pressing the ‘Password’ button and entering a password in the password dialog.

If the user chooses Cancel, the process is stopped.

If the user chooses Build then the process continues.

All options for the files, the password, and the package file name are collected from the build package dialog.

For each file the following occurs:

If the file is opted to be compressed, the DocumentEncoding element for the file has an mpcompression Processing Instruction added to it in the package definition. If the file is also to be encrypted then the mpcompression processing instruction has the ‘protected=“Yes”’ format, otherwise it has the ‘protected=“No”’ (e.g. <?mpcompression protected=“Yes”?> or <?mpcompression protected=“No”?>)

Check for necessary disk space to build the package.

Process steps

Calculate the estimated size of the package to be created.

Get the amount of free disk space on the disk where the user selected to build the package.

If there is not enough space the process is cancelled. Otherwise the process continues.

Save out the package definition to a temporary file

Process steps

The package definition is saved to a file in a temporary directory with the same name as the package with the file extension “.˜tmp”. This file is used to build the package.

Prepare included files for package build by going through file list and perform necessary actions based on the build options selected for the file. At a minimum each file is base64 encoded. Compression/Encryption is done if called for. Prepared temporary files are placed in a temporary directory.

Process steps for each file

Verify that file exists. (Process stops if any file does not exist)

Get build options for file

If compression is called for then the file is compressed to a temporary file. If encryption is also called for, the password is applied during the compression.

The file (temporary file if compressed) is then base64 encoded the final temporary file and is ready for the package build.

The filename is mapped to its temporary file name in a string list through the unique file identifier for the file. (FILEID=temporary file name)

Create the Package file

Process steps

See if the package file already exists and, if it does, determine if it can be overwritten. If cannot then fail the package build process. Otherwise continue.

Open the temporary package definition file into a file stream.

Validate that it is a temporary package definition file by identifying that it has all of the key elements needed to create the package. If it is not valid then fail the package build process. Otherwise continue.

Create and open the file that will be the package into a file stream.

Begin copying the xml data from the package definition into the new package file.

Step through the file identifier map (created in the preparation process) and locate the file identifier comment in the DocumentData element and replace it by:

Copy the starting xml data for the file from the package definition into the new package file.

Opening up the base64 encoded temporary file it is mapped to into a file stream.

Copying it from the opened stream into the new package file.

Close the base64 encoded temporary file stream.

Copy the ending xml data for the file from the package definition into the new package file.

Copy the ending xml data for the package from the package definition into the new package file.

Close the new package file stream. (Thus saving the package)

Close the package definition file stream.

Similarly, in order to preserve an original file's format and to provide the desired speed of file unpackaging, the metadata unpackager utilizes the following methodology. First, a start marker is found. Next, an end marker is found. Then block reconstruction of the embedded file based on a stream read is initiated. The block reconstruction is accomplished using arrays of characters for block reads and writes based on marker positions. The following is a pseudo-code listing of the unpackaging process outlined above.

Extracting Files from an XML Record

Open package

Start metapackager program

Select File | Open from the main menu

This brings up the default windows open file dialog box

Browse to the folder where the package is located.

Select the package file and press the open button to close the dialog.

The file is then validated to be a package.

Process Steps

The package file is opened into a file stream

A read process starts that searches for the Root Element of the xml record.

If the root element is not one of the following it is not a package and the open process fails.

1. metapackage

2. vers:VERSEncapsulatedObject

3. xmlpackager (version 1 metadata package)

It then searches for the packaged document elements (depending on the root element).

It then searches for packaged documents.

If valid root element is found, package document elements are found and there are no packaged documents, the package is valid but does not ‘need extract’. If all items are found then package is valid and ‘needs etract’. Otherwise the package is not valid and the open fails.

If the Root Element is xmlpackager, the user is prompted to convert the package to a version 2 metapackage. If they choose not to convert the package, the process stops.

Process Steps

The package file is renamed to the same name with the extension “.bak”

The renamed package file is opened into a file stream and a new file stream is created with the package file's original name.

The <meta></meta> element is converted into the <PackageMetadata></PackageMetadata> element.

The packaged file is extracted to a temporary file and re-packaged within a <DocumentEncoding><DocumentData>section.

The <FileIdentifier> element within the <DocumentEncoding><EncodingMetadata> section will contain the name of the package without the “.xmlp” extension.

The package file is loaded into the Editor

Process Steps

If the Package does not ‘need extract’ then the xml of the file is parsed and the tree is loaded with the values and the process is ended.

If the Package does ‘need extract’ then the file size of the package is compared to the amount of free disk space on the disk where the metaPackager program is running package. If there is not enough space the process is cancelled. Otherwise the process continues.

The package is opened into a file stream object.

A temporary file is created for the Base64 encoding of each file that is packaged, and the Base64 encoding of each file is copied to that file.

A unique File Identifier is generated for each file and mapped to the temporary file in a string list.

The File Identifier for the file is enclosed in a comment and replaces the section of the file that contained the base64 encoding of the file.

Once all the files have copied to temporary files and mapped to File Identifiers, the remaining xml data is parsed and the tree is loaded with the values and the process is ended.

Extract File(s) from opened package

Select File | Extract File(s) from the main menu

A check is done to make sure that there is a package loaded and that it contains packaged files. If either of these are not true, the process stops.

A list of the file names selected to extract is built.

Process Steps

If the system setting to show the extract dialog is set to true the user is presented with the list of packaged files that are available for extract.

Process Steps

This Extract file dialog is created and the system extract properties are set.

The default extract destination path.

Use foldernames when extracting.

The list view is populated with the names of the available files. By default all files have checkmarks to the left of the name.

The user is allowed to change the extract directory and choose to use the foldernames of the file when extracting.

The user selects or de-selects the file(s) to extract by checking or unchecking the checkboxes to the left of each filename.

If the user presses Ok then, if there are any files selected, the process continues, otherwise the process is stopped.

If the system setting to show the extract dialog is set to False all available files are selected.

If the extract destination path of the files to does not exist then an attempt is made to create it. If it cannot be created then the process fails.

The extract destination path is tested to see if files can be created to it, if not then the process fails.

Each file in the list of files to extract is then checked for packaged compression/encryption options to see if a password is required to extract any file.

Process Steps

The DocumentEncoding element referenced by the file is checked for the mpcompression processing instruction.

If found, it is checked for either the protect=“Yes” or protect=“No” data.

If the data is protect=“Yes” then a password is required for extract. Otherwise, no password is required for the extract.

If a password is required then the user is prompted for a password, if a password is not entered, the process is cancelled. otherwise the process continues.

If the system setting for using foldernames when extracting is set to true, each of the selected file's folder path without the drive is checked to exist beneath the extract destination path. If any do not exist an attempt to create them is made, if it fails then the process fails. The extract destination path plus each of the selected file's folder path without the drive is checked to is tested to see if files can be created to it, if not then the process fails.

The list of files is stepped through and the each selected file is extracted to the designated folder beneath extract destination path (this may be a different folder depending on if the system setting for using foldernames when extracting is set to true, if false then all files are extracted to the extract destination path).

Process Steps for each selected file

The File Identifier is validated against the mapped list of files and the loaded package. If it does not exist in the package, the process fails for the current file and continues with the next file.

The mapped temporary file is checked to exist. If it does not exist, the process fails for the current file and continues to the next file.

Depending on the options selected for the file when it was packaged on of the next three options will execute.

If the file was packaged with the compression option, without encryption, the base64 encoding of the mapped temporary file is then decoded to a temporary file in the destination path for the file of the same name as the file except with the “.˜tmp” extension added to it. The new temporary file is then decompressed to the destination file name.

If the file was packaged with the compression option, with encryption, the password supplied by the user is applied to the decompression process. If the password for the decompression is correct, the file is decompressed, otherwise the process fails for the current file and the process continues with the next file.

If the file was packaged without the compression option, the base64 encoding of the mapped temporary file is then decoded to the destination file name.

Modifications and substitutions by one of ordinary skill in the art are considered to be within the scope of the present invention which is not to be limited except by the claims which follow.

The invention claimed is:

1. A method of packaging and unpackaging files into a markup language wrapper for network search and archive purposes, said method comprising the acts of:
creating at least one package of metadata to associate with at least one file using a markup language;
selecting at least one file to embed with said at least one package of metadata from a plurality of available files; and
building at least one metapackage by embedding said at least one package of metadata and said at least one file in its original form in a markup language wrapper.

2. The method of claim 1 further comprising the acts of storing said at least one metapackage and providing said at least one stored metapackage to consumers over a computer network.

3. The method of claim 2, wherein said computer network comprises an intranet.

4. The method of claim 2, wherein said computer network comprises the Internet.

5. The method of claim 2, further comprising the acts of searching said at least one stored metapackage to identify metapackages including desired metadata values, retrieving said identified metapackages, extracting said at least one embedded file from said identified metapackages and viewing said at least one extracted file in its original form.

6. The method of claim 1, wherein said act of building at least one metapackage by embedding said at least one package of metadata and said at least one file in its original form in a markup language wrapper comprises building said metapackage into an XML record.

7. The method of claim 1, wherein said act of building at least one metapackage comprises password-protecting said metapackage.

8. The method of claim 1, wherein said act of building at least one metapackage comprises compressing said at least one file prior to embedding said at least one file into said at least one metapackage.

9. The method of claim 1, wherein said act of building at least one metapackage comprises encrypting said at least one file prior to embedding said at least one file into said at least one metapackage.

10. The method of claim 1, wherein said act of selecting at least one file to embed with said at least one package of metadata from a plurality of available files comprises selecting a plurality of files and wherein said act of building said metapackage comprises embedding said at least one package of metadata and said plurality of files into a markup language wrapper.

11. The method of claim 1 further comprising the act of storing at least one metapackage within at least one metapackage to create an onion package.

12. A metadata management system for embedding at least one metadata package and at least one file into a metapackage to facilitate network search and archiving services, said system comprising:
a metapackager client including a wizard-based user interface, a metadata packager and a metadata unpackager; and
a metapackager server communicating with a computer network.

13. The metadata management system of claim 7, wherein said metadata packager comprises a markup language processor for creating metapackages encapsulating at least one package of metadata and at least one file.

14. The metadata management system of claim 8, wherein said markup language processor comprises an XML processor.

15. The metadata management system of claim 7, wherein said wizard-based user interface comprises a metadata application wizard providing a point-and-click user interface for creating at least one package of metadata and selecting at least one file to include with said at least one package of metadata into a metapackage.

16. The metadata management system of claim 7, wherein said metadata application wizard comprises at least one user-selectable metadata schema providing enterprise-wide consistency of meta tag names.
